(19) United States
(12) Patent Application Publication
(10) Pub. No.: US 2014/0246531 A1
(43) Pub. Date: Sep. 4, 2014

(54) blender with added blades that are stationary

(71) Applicant: Ricardo Anthony Thompson Mcbean, Hollywood, FL (US)

(72) Inventor: Ricardo Anthony Thompson Mcbean, Hollywood, FL (US)

(21) Appl. No.: 14/197,179

(22) Filed: Mar. 4, 2014

Related U.S. Application Data
(60) Provisional application No. 61/772,484, filed on Mar. 4, 2013.

(51) Int. Cl. A47J 43/07

(52) U.S. Cl. CPC A47J 43/0722
USPC 241/282.1

(57) ABSTRACT

A blender for breaking down food at an averagely faster rate, it comprises of; a jar 2 with a tubular body with outer treading on one end; having a screwed on bottom portion 3 which has a set of rotatable blades 10 built in. The bottom portion 3 of the jar 2 has a cavity of its base along the inner circumference, said cavity includes: at the bottom; a gasket 9, then a stationary blades assembly 4 which is a continuous structure made up of; a ring base 7; on opposite side of its inner circumference of said ring 7 are vertical extensions 5 that each have a portion at the top 6 curved inwards at right angle with one edge sharp 11, these curved inward portions 6 serves as the actual blades 6, another gasket 8 is then places over the ring base 7 of the stationary blades 4 assembly, and the rim close to said outer treading, of the body of the jar 2, sit on the gasket 8 on top. The bottom portion 3 of the jar 2 is screwed on tight to the body of the jar 2 so the gaskets 8 and 9 seals all gaps between the bottom portion 3 of the jar 2, the ring 7 of the blade assembly 4 and the body of the jar 2 in order to prevent leakage and also to keep the stationary blades assembly 4 in a fixed position.

### CROSS-REFERENCE TO RELATED APPLICATION

This application contains properties of provisional application 61/772,484

### FIELD OF INVENTION

This invention relates to blenders, specifically an improvement of the blender by adding non rotatable blades in close proximity to the traditional rotatable blades

### BACKGROUND OF INVENTION

Blenders are used to prepare foods which are consumed directly and indirectly from the blender; for foods that are consumed indirectly such as mixtures for soups and sauces to enhance taste then oxidation is not an issue, however when it comes to food which is directly consumed after blending specifically for nutritional purpose; then one has to take into consideration that a significant amount of nutrients in these foods may be destroyed the longer it is blended. The present invention having an advance blade system comprising of blades in fixed at positions; adjacent to the traditional rotatable blades and which function is to help the rotatable blades in the process of cutting down food to a desired texture, while the blender uses basically the same amount of energy to function. As result of the additional cutting done by these fixed blades; the process of cutting down food to a desired texture is speeded up significantly, allowing the user to turn off the blender sooner causing less oxidation to occur.

To be specific the fixed blades are at a position so that whenever the traditional rotatable blades spin and cut downs foods they also carries and slams food against the fixed blades causing the food to be further broken down; this feature of the present invention is radical and sets it apart from other blenders. Most other blenders which offer a design to more efficiently break down food; simply has a slight variation of what is basically the same technology, whether it be a different angled set of blades, different shape containers, a mini version of a blender referred to as a personal blender or a blender with a more powerful motor, they all follow the same concept when it comes to breaking down food. However in the present invention food is broken down by being caught between two sets of blades which is a more efficient way of breaking down food to a desired consistency.

One particular prior art with some similarities to the present invention in that it has an additional set of blades is the Multi-Blade Blender Apparatus; application number PCT/US2004/023411, in this prior art both set of blades are rotatable and spin simultaneously to cause a double cutting effect to breaks down food at a faster rate in contrast to a regular blender. However the Multi-Blade Blender Apparatus faces some disadvantages: first the Multi-Blade Blender has more parts than the average blender making it more technical and expensive to manufacture in terms of materials, tooling up, labor and energy, as a result it may be a more expensive product for the consumer, also with more technical parts the possibility of malfunctioning increases. Second; even though the Multi-Blade Blender may break down food faster than regular blenders it does not necessarily solve the problem of oxidation, as multiple blades spinning at the same time mixes even more oxygen with the food being broken down causing more oxidation of the food. And third; it has two blade assemblies and related gears which causes extra drag on the motor while the blades spins and chops food, therefore a bigger motor using more ellectricity may be necessary to operate the Multi Blade Blender.

The present invention also has an additional set of blade and gasket(s) however the advantages are: these parts are more simplistic than that of the Multi-Blade Blender as they are fixed in the jar of the blender as oppose to the blender base, they stay in a stationary position; being in a stationary position reduces ware and tare and possible malfunctioning, it requires no driving shaft with the technical parts and assemblies that come with such shaft and is therefore fitted in the blender jar by less technical procedure on an assembly line during the manufacturing process. As a result it is unlikely that the stationary blade assembly of the present invention will not significantly if at all result in a more expensive product. The main advantage however is the fact that there is only one set of blades rotating to break food down so there is no increase in oxidation but instead with the help of the stationary blades also breaking down food the time taken to bring food to a desired texture is reduce so the blending process takes less time resulting in less oxidation. Also the fact that the stationary blades are not connected to the drive shaft; there is no direct drag on the motor, but an indirect drag caused by the stationary blades may occur but is limited; according to the number, width and sharpness of the blades, and therefore having these stationary blades does not necessarily mean an averagely bigger motor is needed in direct relation to them.

### SUMMARY

The present invention comprises of a blender jar having a set of blades that are stationary and for use of aiding the traditional rotatable blades in the process of chopping up food; by being in close proximity to the rotatable blades so as to receive food being carried by the force of their rotation.

### DRAWINGS

FIG. 1 shows a front view of one embodiment of the blender with broken away portions.

FIG. 2 shows, in the order of assembly, the individual parts of the same embodiment of FIG. 1 with the parts labeled 4, 8 and 9 being shown from a perspective view.

FIG. 3 shows a cutaway side view of a second embodiment of the blender jar

FIG. 4 shows, in the order of assembly, the individual parts of the same embodiment of FIG. 3 with the parts labeled 18, 20 and 16 being shown from a perspective view, while part 12 is a cross sectional view of the lower portion of the jar.

FIG. 5 shows the lower fig labeled 42 being a cutaway side view of the lower portion of a third embodiment of the blender jar, the two top FIGS. 43 and 48 are perspective views of same parts shown in lower fig labeled 42.

FIG. 6 shows a cutaway side view of the lower portion of a forth embodiment of the blender jar.

FIG. 7 shows a perspective view of each assembly of the blade of the same embodiment of FIG. 6.

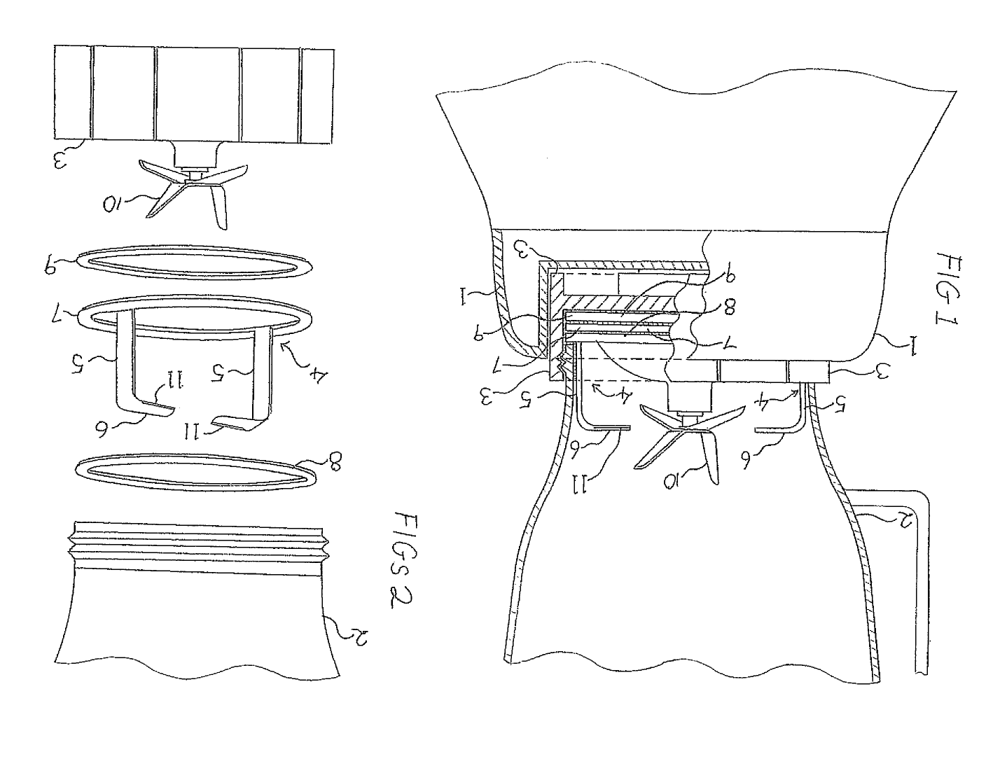

### PREFERRED EMBODIMENT FIG. 1-FIG. 2

FIG. 1 shows a front view of one embodiment of the blender with a broken away top and bottom. It shows the blender jar 2 in the blender base 1 that is also broken away to show the assembled parts of the jar 2; which includes a tubular body with outer treading on one end screwed into a bottom portion 3 with inner treading. The bottom portion 3 comprises: a set of rotatable blades at a raised center which results in a cavity along its circumference; below said inner treading, said cavity includes: a gasket 9 at the bottom, then a stationary blades assembly 4 which is a continuous structure made up of: a ring base 7, on opposite side of the inner circumference of said ring 7 are vertical extensions 5 that each have a portion at the top 6 curved inwards at right angle with one edge sharp 11, these curved inward portions are blades 6, another gasket 8 is then places over the ring base 7 of the stationary blades 4 assembly, and the rim adjacent to the treading of said tubular body of the jar 2; sit on said gasket 8 on top.

FIG. 2 shows in order of assembly; the individual parts of FIG. 1, the stationary blades assembly 4 and the gaskets 8 and 9 are shown from a perspective view. When assembled as in FIG. 1, the bottom portion 3 of the jar 2 is screwed on tight to the tubular body of the jar 2 so the gaskets 8 and 9 seals all gaps between the bottom portion 3 of the jar 2, the ring 7 of the blade assembly 4 and said body of the jar 2 in order to prevent leakage and also to keep the stationary blades assembly 4 in a fixed position.

The procedure of operation is; whenever said rotatable blades 10 rotate and chops food while creating a vortex, the rotation of the blades 10 and the vortex they create; carries and slams food, in a cycling process, against the edges of the stationary blade 6 which also cause the food to be chopped up, and as a result the process of breaking down food in this type of blender is much faster than that of traditional blenders without any such stationary blade assembly 4.

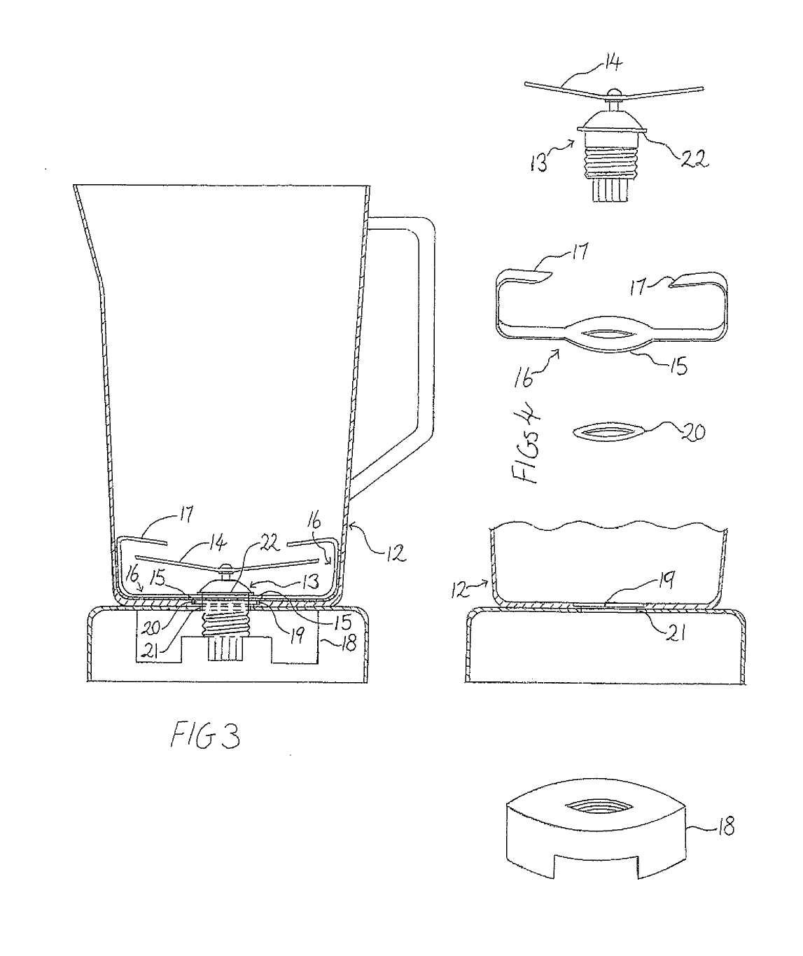

### Additional Embodiment FIG. 3-FIG. 4

FIG. 3 shows a cutaway side view of a second embodiment of the blender jar 12, it shows the jar 12 having a circular hole 21 at the bottom center, along the circumference of the hole 21 is a notch 19 that faces the inside of the jar 12, inside the notch 19 is a gasket 20 with a width just bigger than the depth of said notch 19. A stationary blades assembly 16 is place on the gasket 20, the stationary blades assembly 16 is a continuous structure with a design comprising of: a ring portion 15 at the bottom center, on opposite sides of said ring 15 are extension each of which contours to the shape of the lower jar 12 and has a top portion extending inwards; that serves as the actual blade 17. The hole 21 in the jar 12, the inner circumference of the gasket 20 and the inner circumference of the ring 15 of the stationary blades assembly 16 are about the same size which is just bigger than the body of a rotatable blades assembly 13 to fit through to the point of a raised edge 22 along the circumference of the upper portion of said rotatable blades assembly 13, this raised edge 22 therefore serves as a stop. A nut type device 18 having inner treading, that matches treading on the lower body of the rotatable blades assembly 13, is used to tighten both stationary 16 and rotatable 13 blades assemblies to the jar 12 and in the process the gasket 20 which has more width than the notch 19 it is placed in; is squished flushed with the bottom surface of the jar 12 and as a result creates a seal against leakage. The actual blades 14 of the rotatable blades assembly 13 is positioned below the blades 17 of the stationary blades assembly 16.

FIG. 4 shows in the order of assembly; the individual parts of the same jar 12 of FIG. 3, the nut 18, the gasket 20 and the stationary blades assembly 16 are shown from a perspective view, also is a cross sectional view of the lower portion of the jar 12.

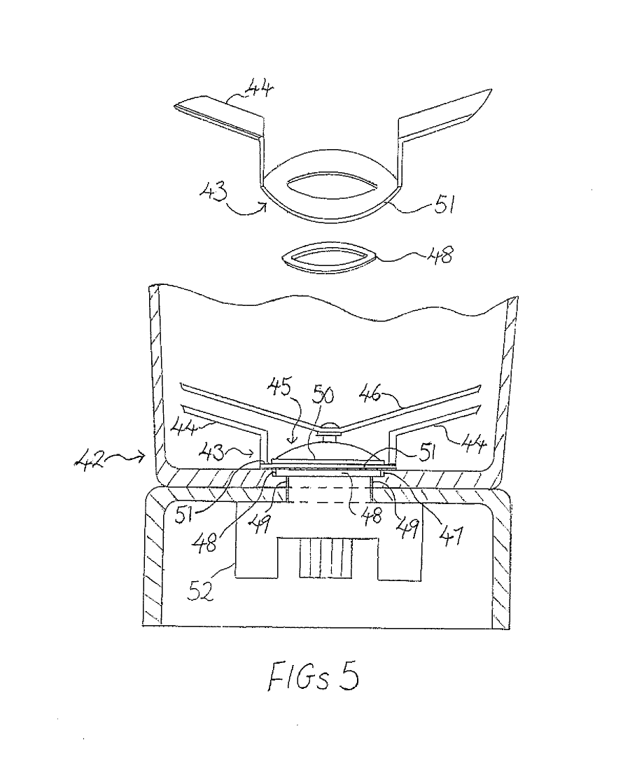

### Additional Embodiment FIG. 5

FIG. 5 shows the lower figure being a cutaway side view of the lower portion of a third embodiment of the blender jar; it is assembled similar to that of FIG. 3. It shows the jar 42 having a hole 49 that is circular, along the circumference of the hole 49 is a notch 47, inside the notch 47 is a gasket 48 with a width just bigger than the depth of the notch 47. A stationary blades assembly 43 is placed on the gasket 48. The stationary blades assembly is a continuous structure with a design comprising of: a ring base 51, a right angle extension on opposite sides of the ring 51, the top portion of each extensions are slanted outwards and serves as the actual blades 44. The hole 49 in the jar 42, the inner circumference of the gasket 48 and inner circumference of the ring 51 of the stationary blades assembly 43 are the same size which is just bigger than the body of the rotatable blades assembly 45 to fit through to the point of a raised edge 50 along the circumference of the upper portion of said rotatable blades assembly 45, this raised edge 50 therefore serves as a stop. A nut type device 52 having inner treading that matches treading on the lower body of the rotatable blades assembly 45; is used to tighten both stationary 43 and rotatable 45 blades assemblies to the jar 42 and in the process the gasket 48 which has more width than the depth of the notch 47 it is placed in; is squished flushed with the bottom surface of the jar 42 and as a result creates a seal against leakage. The blades 46 of the rotatable blades assembly 45 is above and parallel to the blades 44 of the stationary blades assembly 43. The figs seen above include; a perspective view of the stationary blade assembly 43 and a perspective of the gasket 48.

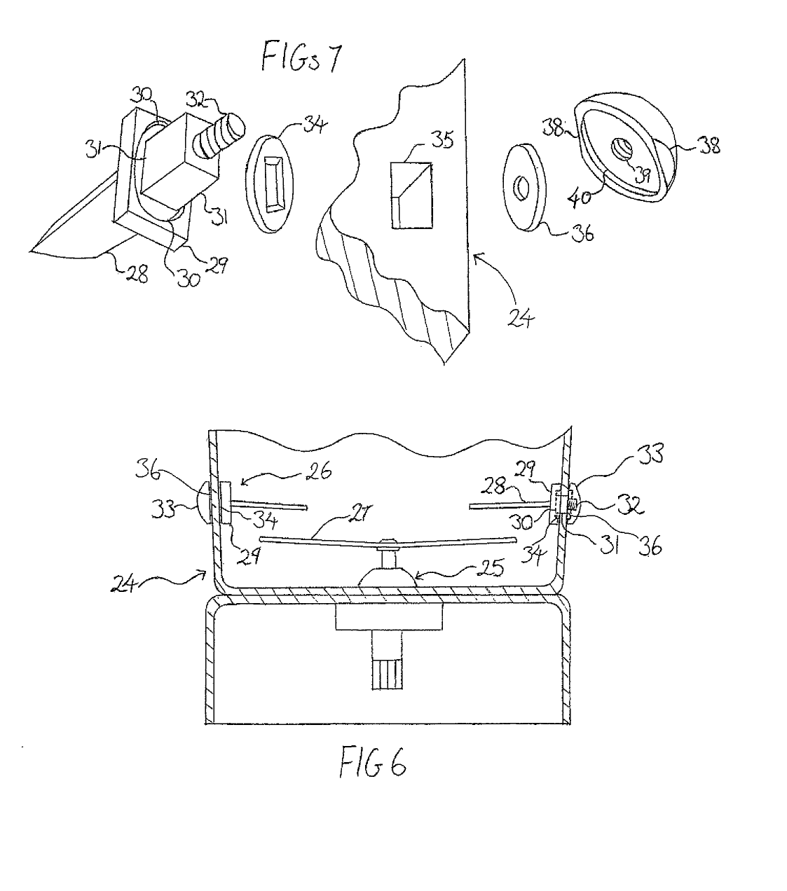

### Additional Embodiment FIG. 6-FIG. 7

FIG. 6-FIG. 7 shows a forth embodiment of the present invention, FIG. 6 shows the lower portion of a blender jar 24 with a set stationary blades each assembled on opposite side of the jar 24, while FIG. 7 shows the separate parts of the blade assemblies in the order they are to be assembled. Both figs shows the stationary blade assemblies each having of a continuous structure which is mainly a blade 28 but having other portions; namely: a flat rectangular portion 29 that is connected to the blade portion 28 at right angle and serves as a stop, on the side of the rectangular portion 29 opposite the blade 28; is circular cavity 30, from this cavity 30 extends a cubical portion 31 with a screw portion 32 on its top center, a gasket 34 having a rectangular hole is fitted over said cubical portion 31 and in the cavity 30 of the rectangular portion 29. On the lower portion of the jar 24 are rectangular holes 35 on opposite sides, these holes 35 are just big enough for the cubical portion 31 of said blade 28 structure to fit into, the width of the wall of the jar 24 and the horizontal width of said cubical portion 31 of said blade 28 structure are about the same. The blade 28 structures each with an attached gasket 34 are then fitted to the jar 24 by use of the rectangular portion 31 being placed through one of the holes 35 on each side of the jar 24, in this position each screw portion 32 sticks outside the jar. The assembling is completed by another gasket 36 having a circular hole being placed over the screw portions 32 of each said blade 28 structures, a nut 33; with a matching wide cavity 40 and cavity with treading 49 for the outer gasket 36 and said screw portion 32 respectively, is screwed and tightened to each screw portion 32 which as a result squishes the gaskets 34 and 36 to prevent leaking while securing said blade 28 structure to the jar 24, each nut 33 has a flat part 38 on opposite sides so that a tool can be used to tighten them.

### Operation FIGS. 1, 3, 5, 6

The blender of the present invention is for use of breaking down food to a desired texture by a procedure of placing food in the blender jar before and sometimes during the operation of the blender. Whenever the blender is turned on said rotatable blades rotate and chops food breaking it down while simultaneously creating a vortex, the rotating blades and the vortex created; carries and repeatedly slams the food against the edges of said stationary blades which cause the food to further break down, therefore with the aid of said stationary blades also breaking down food, the process of breaking down food in the blender is speeded up and a desired texture is reach much sooner.

Immediately after use while inside the jar is moist the jar is easily washed out by conventional methods, however after a certain amount of use whereby the jar needs to be thoroughly cleaned; then the stationary blade components can be easily disassemble as seen in FIGS. 2, 4, 5, and 7 through a reverse of the assembling described in the above specifications.

### Conclusion and Scope

If one looks at a blender in operation then it will be noticed that initially the rotating blades chops the food much easier as there are bigger pieces clustered in the bottom of the jar which together holds in a firm position. But as the food is broken down further the chopping process slows down, this is because these smaller pieces of food is now in a vertex which is traveling in the same direction as the blade and so when the blades catch up with these pieces they do not hit them with the same impact as in the initial stage where the food was held firm. With the use of stationary blades in the present invention; food is chopped from both directions immediately and when a vertex is formed food is still being chopped from two direction as oppose to only in the direction of the vertex and being hit from behind with a limited force from the blade, but instead food is also being slammed onto a blade which is an effective way of breaking down food. With the use these stationary blades food does not only travel in a set motion due to the vertex but is also deflected back and forth by both set of blades. And so the fact that food is being broken down by two set of blades and is also being deflected back and forth; this increases the probability of each piece of food being cut down to a smaller size within a given amount of time. It is clear that any blender of any technology that a set of stationary blades are added to will not interfere with but instead only improve the use of that type of blender.

The specifications above thus far have been focused on improving the blender by adding a set of stationary blades that are generally horizontally positioned to aid the traditional rotatable blades in the process of breaking down food; this is because these versions better illustrates the concept most effectively. However within the same concept of having a device in the blender jar that is stationary and which food can be slammed against by set of rotating blades and as a result break down said food; then such a device or devices does not necessarily has to be horizontally fixed blades, also such a device or devices does not have to be blades. The concept can be as versatile as having vertically positioned blades which may be just as effective as horizontal blades, for example where stationary blades are not used; the rotatable blades could be in close proximity to a textured part of the inner surface of the container; such that food is broken down when forced against such texture by the rotating blades. The broadness of the concept of the present invention is covered by the attached claims.

I claim:

1. A type of blender having at least one stationary blade in addition to the traditional rotatable blades that may be of any conventional technology used in blenders, said stationary blade is positioned so that whenever said rotatable blades rotate; they pass alongside said stationary blade,
(a) said stationary blade preferably has one end sharp which points in the opposite direction to which said rotatable blades spins
(b) said stationary blade is; more or less, vertically or horizontally positioned
(c) there are preferably two to four of said stationary blade
(d) a means to attach said stationary blades inside the blender jar
Whereby; whenever said rotatable blades rotate and chops food breaking it down while simultaneously creating a vortex; the rotating blades and the vortex created; carries and repeatedly slams the food against the edges of said stationary blades which cause the food to be further broken down, therefore with the aid of said stationary blades also breaking down food; the result is a faster process of breaking down food when using said type of blender.

2. in claim 1 wherein said stationary blades are of an assembly which is a continuous structure comprising of: a ring base, on opposite sides of the inner circumference of said ring is a vertical extension; each having a top portion curved inwards at right angle with one edge sharp.

3. In claim 1 wherein said blender has a circular jar comprising of a tubular body having outer treading on one end with a screw on bottom portion, said bottom portion is comprised of: a short circumference wall with treading on the inner surface, a set of rotatable blades at the center which is raised and has a round shape resulting in cavity along it circumference; bellow said treading, inside said cavity is: a gasket at the bottom, on top of said gasket is said ring portion of said assembly of claim 2; said ring is the same size of said gasket, a second gasket sits on top of said ring base; said second gasket is the same size as said ring, the rim adjacent to said outer treading of said tubular body sits on top of said second gasket.

4. In claim 1 wherein said stationary blades are part of an assembly that is continuous structure with a design comprising of a ring portion at the bottom center, on opposite sides of said ring is an extension; each of which extends outwards horizontally, then upwards at right angle, then inwards at right angle.

5. In claim 1 wherein said rotatable blades are of an assembly comprising of; a cylindrical body with treading on the lower portion and a coupling on its bottom end, from the top of said body extends a rotatable shaft with blades on opposite sides, and closer to the top of said body is a raised edge along its circumference.

6. In claim 1 wherein said blender jar has a circular hole at its bottom center, along the circumference of said hole is a notch facing the inside of the jar, inside the notch is a gasket with a width jus bigger than the depth of said notch, the ring portion of said assembly of claim 4 sits on said gasket, said hole, the inner circumference of said gasket and the inner circumference of said ring are about the same size which is just bigger than said cylindrical body of the assembly of claim 5 but smaller than said raised edge of said cylindrical assembly; allowing said cylindrical assembly to fit through but stops at said raised edge, a nut type device having inner treading, that matches treading on said cylindrical assembly, is used to tighten both said stationary and rotatable blades assemblies of claims 4 and 5 respectively; to the jar and in the process said gasket is squished flushed with the bottom of the jar and as a result creates a seal against leakage.

7. In claim 1 wherein said stationary blades are part of an assembly which is a continuous structure with a design comprising of: a ring base with an extension on opposite sides; each extending upwards at right angle from said ring then a portion slanting out and upwards.

8. Said blade assembly of claim 7 is assembled to the jar in the same way as said blade assembly of claim 4 as describes in claim 6, when assembled said extensions of claim 7 sits bellow and is parallel to said rotatable blades of claim 5.

9. In claim 1 wherein said blades are two assemblies each of a continuous structure which is mainly a blade but having other portions; namely: a flat rectangular portion that is connected to the blade portion at right angle and serves as a stop, on the side of said rectangular portion opposite said blade; is circular cavity, from said cavity extends a cubical portion with a screw portion on its top center.

10. In claim 1 wherein said jar has rectangular holes on opposite sides of the lower portion, said holes are each just big enough for the cubical portion of each said blade assembly of claim 9 to fit into, the width of the wall of the jar and the horizontal width of said cubical portion of each said blade assembly are about the same, a gasket having a rectangular hole is fitted over said cubical portion and into said cavity of each said blade assembly, each said blade assembly is then fitted to the jar by use of the rectangular portion of said blade assembly being placed through one of said holes on each side of the jar, in this position each said screw portion sticks outside the jar, another gasket having a circular hole is placed over said screw portions of each said blade assembly, a nut; with a matching wide cavity and cavity with treading for the outer gasket and said screw portion respectively; is screwed and tightened to each screw portion which as a result squishes both said gaskets to prevent leakage while securing said blade assembly to the jar, each nut is flat on opposite sides so a tool can be used to tightened them.

11. The blender jar of claim 10 has a set of rotatable blades of any type; attached by use of any conventional means.

12. A type of blender jar having standard rotatable blades and at least one non rotatable blade at a fixed position; so that whenever said rotatable blades spin and chops food while creating a vortex, the rotation of said rotatable blades and/or the vortex they create; carries and slams food, in a cycling process, against the edge of said fixed blade which also cause the food to be chopped up, and as a result the process of breaking down food in said type of blender jar is much faster than that of traditional blender jars without said non rotatable blade.

13. An improvement of the blender jar having rotatable blades, said improvement comprises of; at least one device of a type and at a fixed position: such that whenever food is forced onto or against said fixed device due to the spinning motion of said rotatable blades; said food is broken down, therefore with the traditional use of said rotatable blades which is to break down food by means of spinning, and said fixed device also breaking down food by use of the same spinning force of said rotatable blades, the result is less time taken for food to be broken down to a desired texture.
